(19) United States
(12) Patent Application Publication
(10) Pub. No.: US 2012/0023515 A1
(43) Pub. Date: Jan. 26, 2012

(54) Method of Providing a TV Network

(76) Inventor: William Walker, III, Upper Marlboro, MD (US)

(21) Appl. No.: 13/084,152

(22) Filed: Apr. 11, 2011

Related U.S. Application Data
(60) Provisional application No. 61/322,341, filed on Apr. 9, 2010.

(51) Int. Cl. H04H 60/33; H04N 7/173

(52) U.S. Cl. 725/9; 725/105

(57) ABSTRACT

A television and computer network that provides an exclusive platform for female Christian spiritual leaders to reach the enormously growing network through TV and the Internet worldwide.

### CROSS REFERENCE TO RELATED APPLICATION

This application is based upon and claims benefit of copending and co-owned U.S. Provisional Patent Application Ser. No. 61/322,341 entitled “Method of Providing a TV Network”, filed with the U.S. Patent and Trademark Office on Apr. 9, 2010 by the inventor herein, the specification of which is incorporated herein by reference.

### BACKGROUND

1. Field of the Invention

This invention relates to video distribution and production. More particularly, this invention relates to providing a television network directed to Christian women.

2. Summary

The female Christian audience is tremendous. According to the National Council of the Churches of Christ in the USA, there are more than 360,000 churches in America, representing 160 million members. About 70 percent of the congregation is women and they contribute billions in tithes and offerings, as well as make large contributions embodied in their talents and time. Nevertheless, reports show that 70 percent or more of the bishops, priests, and pastors are male. WCAN will provide an exclusive platform for female Christian spiritual leaders to reach the enormously growing network through TV and the Internet worldwide.

### DESCRIPTION OF PREFERRED EMBODIMENTS

The Women's Christian Action Network (WCAN) is a multi-faceted television network designed to motivate, activate, and inspire women and young girls through multi-media. WCAN provides women clergy (pastors, priests, ministers, and evangelists), along with the faithful female laity toiling in the spiritual vineyards, the opportunity to televise their sermons and various ministries on the network to a national and global viewing audience.

This innovative cutting edge network is the first of its kind and focuses global attention not only on the status of children, health, and financial issues that pertain specifically to women, but also to aid women in showcasing their achievements in foreign affairs, international diplomacy, sports, technology, and communications—information is power. In addition, the lack of information creates a vacuum and blocks access to opportunity. Following the mandate of Christ, this network is designed to help set the captives free, whether the bondage is domestic violence, mis-education, or the continued bombardment of negative and pornographic images depicting women as vile objects. WCAN is a powerful informational resource that can be appreciated on every level of society, from the very poor to the very rich.

The programming available on WCAN spiritually enlightens, educates, entertains, and gives women and girls the opportunity to touch the lives of other women and girls on a global level by sharing the power of Jesus Christ through outreach media, Ministry Groups, and discipleship. Through this channel, Christian women will touch the world in various and creative ways, reaching beyond personal interests and comfort zones to embrace people of all ages, races, professions, and social standings. The presenters are building an environment for women to serve as mentors in an environment where people can learn, practice biblical love, and feel God's love in a very real way.

The network is grounded on five basic principles:

REACHING women through the transforming power and love in a spiritual environment.

MENTORING women to live life in a spiritual way; no matter what their religious backgrounds are.

BUILDING wholeness and balance, both spiritually and mentally, through consistent prayer and faithful study.

PROVIDING an atmosphere for women to develop their gifts, abilities, and lasting relationships.

TRAINING women to find their places of ministry and effectively touch their world through faith.

WCAN targets the Christian female market, which has been growing dramatically in the last several years. WCAN spotlights various types of programming that focuses on traditional and non-traditional ministries that are created by women and girls that do not trample on basic Christian standards of integrity, fairness, and decency. WCAN has created 20 percent of its programming with offers from other organizations such as “National Women” and “Women National” as they eagerly await joining the network. WCAN has the potential to branch into new venues as the company grows.

There are three phases to the development of the network:

### Advertising & Sponsorship:

Current TV Advertising rules permit up to 9 minutes per hour of advertising, 432×30-second ad spots per day. giving 1,314 hours per year. Most commercial TV channels derive the majority of their revenue from Advertising and Sponsorship in the main broadcast TV stream; this is also true of most providers of video over the Internet.

### Subscriptions:

Viewers can subscribe to the WCAN network, which should not be a problem because of the content and target audience, Christian women and girls.

### Participation:

The network provides two-way interaction. Participation on the WCAN network is in the form of integrated communications used to motivate viewers to participate in events and interact with content and brands. Essentially, it encapsulates every activity where a viewer pays to respond to content. Clients will have access to multi-media, such as Mod, web casting, streaming, and U-Tube.

The web is the natural convergence point for all platforms and media for a TV channel and of course the easiest and most secure access point to attract consumers. The web is often the most effective way of distributing exclusive content for a one-time payment or a subscription, and it can be used to promote programs and enhance campaigns being broadcast on the main TV channel. Shopping initiatives can be channeled through the web and relationships with viewers can be developed and personalized with varying degrees of sophistication and depth to satisfy web advertisers who wish to deliver targeted advertisements to specific users.

What is claimed is:

1. A method of providing a television network, comprising:
gathering video content; and
enabling display of the video content over commercial airwaves and over a computer network;
wherein said video content spotlights various types of programming that focuses on traditional and non-traditional ministries.

2. The method of claim 1, further comprising:
producing video content.

3. The method of claim 1, further comprising:
enabling communication feedback from a viewer.

4. The method of claim 1, further comprising:
enabling viewers to obtain a subscription to view the video content.
